(19) United States
(12) Patent Application Publication
(10) Pub. No.: US 2009/0251514 A1
(43) Pub. Date: Oct. 8, 2009

(54) Universal ink cartridge seal

(75) Inventors: Anthony D. Causey, Fuquay-Varina, NC (US); Christopher E. Nichols, Raleigh, NC (US); Glenn L. Szabo, Sanford, NC (US); Joe H. Melvin, JR., Sanford, NC (US)

Correspondence Address: WILLIAM L. LONDON, 3010 LEE AVENUE, P.O. BOX 152, SANFORD, NC, 27330, US

(73) Assignee: Static Control Components, Inc., Sanford, NC (US)

(21) Appl. No.: 12/080,965

(22) Filed: Apr. 8, 2008

(51) Int. Cl. B41J 2/175; F16J 15/14; B41J 2/165

(52) U.S. Cl. 347/86; 277/590; 347/29

(57) ABSTRACT

A universal ink cartridge seal is disclosed. The seal is used to seal an exit port on an ink jet cartridge. The seal has a top and a surrounding wall. The surrounding wall extends perpendicularly away from the circumference of the top. The surrounding wall has an inside surface. The seal further has a rib positioned on the inside surface of the surrounding wall, the rib providing a securing force when the seal is installed on the exit port of the ink jet cartridge.

### FIELD OF INVENTION

The present invention relates to remanufacturing of imaging process cartridges, such as printer ink jet cartridges, and more particularly to a universal cartridge seal for use in an ink jet cartridge.

### BACKGROUND

Printer ink jet cartridges are typically designed to provide the consumer a certain number of print copies before the ink is exhausted. The total number of prints varies depending on the type, quality and density of the print provided by the printer. After all of the ink is spent, the ink jet cartridges are either thrown away or recycled.

An emerging industry has developed that deals with the recycling of printer cartridges. Typically, the OEM (Original Equipment Manufactured) printer cartridge is recycled by a printer cartridge remanufacturer, who receives spent printer cartridges and refurbishes them. The ink jet cartridge remanufacturing process typically entails cleaning the cartridge, refilling the cartridge and sealing the cartridge for shipment.

Typically the OEM cartridge manufacturer may attach a seal on to the ink jet cartridge using ultrasonic welds, clips, heat stakes, adhesives or mounting hardware. Existing seals may cover the exit port and prevent ink from leaking out the exit port during shipment of the ink jet cartridge to the consumer. After the consumer receives the OEM ink jet cartridge, the seal is removed and discarded. In addition, the consumer usually removes another seal that covers the ink jet vent port. If the consumer does not remove the ink jet vent port seal, the ink jet cartridge may not function properly when installed into the ink jet printer.

Current exit port seals and vent port seals are two separate seals. In addition, an exit port seal may not be reattached to a remanufactured ink jet cartridge because the mounting hardware may not be reused. In addition, it may be difficult or not cost effective to ultrasonically weld the exit port seal in place. In addition, the existing exit port seals may not have enough securing force to be held in place with out additional securing fixtures positioned on the outside of the exit port seal. There exists a need in the industry for a universal ink cartridge seal that may be attached to the exit port without using an ultrasonic weld or heat stakes by using structures on the inside of the exit port seal. Additionally, the exit port seal and the vent seal may be a single assembly allowing the consumer to remove one seal instead of two seals when installing the ink jet cartridge into the ink jet printer.

### SUMMARY

The present disclosure recognizes these needs and discloses such a seal. A seal for sealing an exit port on an ink jet cartridge is disclosed. The seal has a top and a surrounding wall. The surrounding wall extends perpendicularly away from the circumference of the top. The surrounding wall has an inside surface. The seal further has a rib positioned on the inside surface of the surrounding wall, the rib providing a securing force when the seal is installed on the exit port of the ink jet cartridge.

An integrated seal assembly is disclosed. The integrated seal assembly has an exit port seal for sealing an exit port on an ink jet cartridge, a vent port seal for sealing a vent port on an ink jet cartridge, and a connecting member connecting the exit port seal with the vent port seal.

A method for sealing an exit port and a vent port in an ink jet cartridge is disclosed. The method provides the ink jet cartridge having the exit port and the vent port. The method further positions an integrated seal assembly having an exit port seal connected to a vent port seal by a connecting member, the exit port seal positioned over the exit port and the vent port seal positioned over the vent port. The method secures the integrated seal assembly in place.

A more complete understanding of the present invention, as well as further features and advantages of the invention, will be apparent from the following detailed description and the accompanying drawings.

### BRIEF DESCRIPTION OF THE DRAWINGS

FIG. 1A shows a top perspective view of a Canon CLI-8 ink jet cartridge.

FIG. 1B shows a bottom perspective view of the Canon CLI-8 ink jet cartridge.

FIG. 2A shows a side perspective view of an exit port seal in accordance with one embodiment of the present invention.

FIG. 2B shows a bottom view of the exit port seal of FIG. 2A.

FIG. 2C shows a side view of the exit port seal of FIG. 2A.

FIG. 3A shows a top perspective view of an integrated seal assembly consisting of an exit port seal and a vent seal in accordance with one embodiment of the present invention.

FIG. 3B shows a bottom perspective view of the seal assembly of FIG. 3A.

FIG. 4A shows a top perspective view of the seal assembly of FIGS. 3A-B attached to an ink jet cartridge.

FIG. 4B shows a bottom perspective view of the seal assembly of FIGS. 3A-B attached to the ink jet cartridge.

FIG. 5A shows a top perspective view of an integrated seal assembly consisting of an exit port seal and a vent seal in accordance with a further embodiment of the present invention.

FIG. 5B shows a bottom perspective view of the seal assembly of FIG. 5A.

FIG. 6A shows a top perspective view of the seal assembly of FIGS. 5A-B attached to an ink jet cartridge.

FIG. 6B shows a bottom perspective view of the seal assembly of FIGS. 5A-B attached to the ink jet cartridge.

FIG. 7A shows a top perspective view of an integrated seal assembly consisting of an exit port seal and a vent seal in accordance with another embodiment of the present invention.

FIG. 7B shows a bottom perspective view of the seal assembly of FIG. 7A.

FIG. 8A shows a top perspective view of the seal assembly of FIGS. 7A-B attached to an ink jet cartridge.

FIG. 8B shows a bottom perspective view of the seal assembly of FIGS. 7A-B attached to the ink jet cartridge.

FIG. 9A shows a top perspective view of an integrated seal assembly consisting of an exit port seal and a vent seal in accordance with a further embodiment of the present invention.

FIG. 9B shows a bottom perspective view of the seal assembly of FIG. 9A.

FIG. 10A shows a top perspective view of the seal assembly of FIGS. 9A-B attached to an ink jet cartridge.

FIG. 10B shows a bottom perspective view of the seal assembly of FIGS. 9A-B attached to the ink jet cartridge.

### DETAILED DESCRIPTION

The following detailed description of preferred embodiments refers to the accompanying drawings, which illustrate specific embodiments of the invention. In the discussion that follows, specific systems and techniques for repairing, manufacturing or remanufacturing an imaging cartridge, such as an ink jet cartridge are used as examples. Other embodiments having different structures and operations for the repair, remanufacture and operation of other types of replaceable imaging components and for various types of imaging devices, such as laser printers, inkjet printers, copiers, facsimile machines and the like, do not depart from the scope of the present invention.

In the ink jet cartridge refurbishment industry, the used ink jet cartridges are collected and serviced by ink jet cartridge remanufacturers. The first step in the refurbishment process is the cleaning of the spent cartridges. Next, any electronics mounted with the ink jet cartridge are replaced. After the electronics have been replaced, the cartridge is sealed to prepare the ink jet cartridge for shipment. This may entail attaching a seal or seal assembly or the like to prevent the ink from leaking out of the ink jet cartridge during shipment. The seal or seal assembly may be removed by the consumer after the ink jet is received and prior to installing the ink jet cartridge in the ink jet printer. The last step on the refurbishment process is filling the ink jet cartridge with ink.

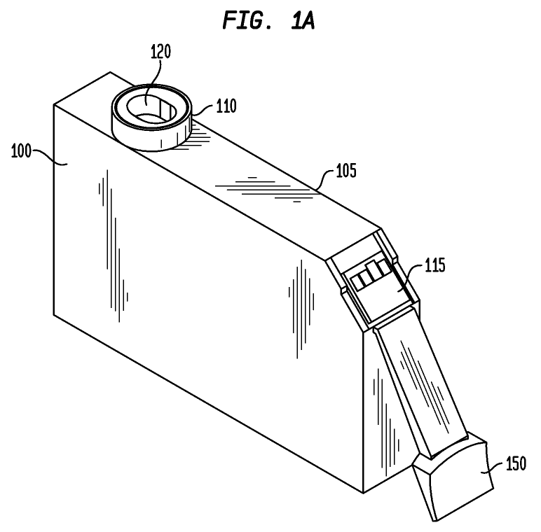

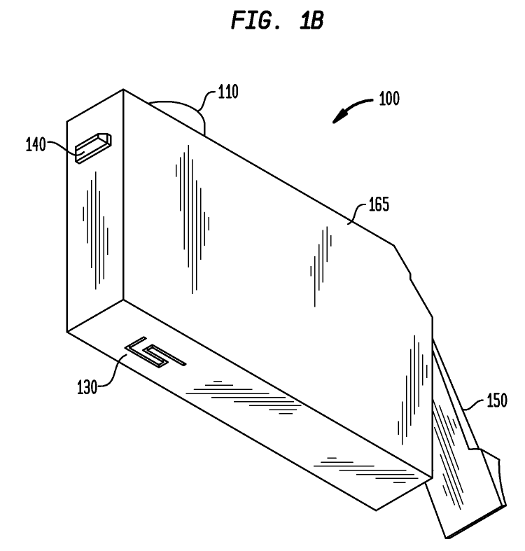

The inventive concepts of the present invention are more clearly understood in reference to the ink jet cartridge 100 displayed in FIG. 1A. The ink jet cartridge 100 may be compatible with the Canon CLI-8 or PGI-5 ink jet cartridge which may be used in various printers such as but not limited to the Canon PIXMA iP4200/iP4300/iP4500/iP5200/iP6600D/iP6700D/MP500/MP600/MP800/MP950/Pro 9000 inkjet printers. The ink jet cartridge 100 has a main body 105, an exit port 110 and an exit port opening 120. Positioned on the ink jet cartridge 100 is an electronic chip 115 for communicating with the printer when the ink jet cartridge 100 is installed. The ink jet cartridge has a handle 150 for facilitating the ink jet cartridge installation and removal.

FIG. 1B displays a bottom perspective view of the ink jet cartridge 100. From this view, the ink jet cartridge 100 has a securing tab 140 positioned on the back side of the main body 105. When the ink jet cartridge 100 is installed in the ink jet cartridge compartment the securing tab 140 fits into a depression located within the ink jet cartridge compartment and may provide alignment as well as securing properties. On the bottom of the main body 105, is a vent 130. When open, the vent 130 allows air to flow into the ink jet cartridge 100 and facilitates the movement of ink out of the exit port opening 120 of the exit port 110 and into the printer when the ink jet cartridge 100 is installed in the ink jet printer.

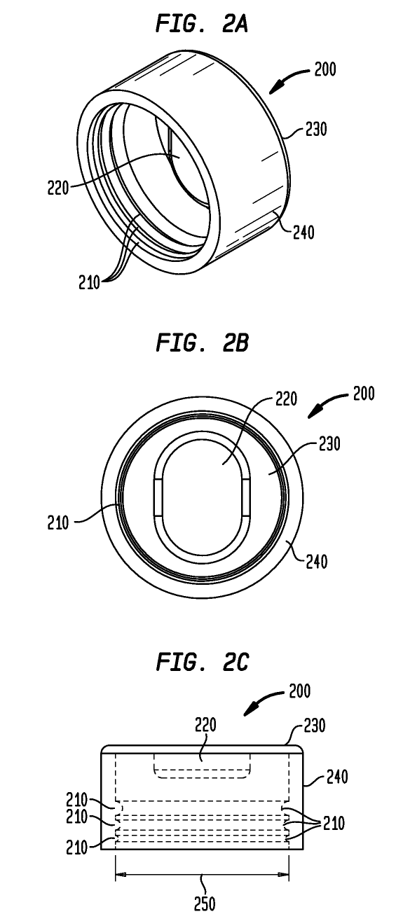

FIG. 2A displays a seal 200 in accordance with one embodiment of the present invention. The seal 200 has a top 230 and a surrounding wall 240 that extends perpendicularly away from the circumference of the top 230. On the inside of the surrounding wall 240 are ribs 210 that extend away from the interior surrounding wall surface. Protruding away from the inside of the top 230 is a plug 220. When the seal 200 is installed on the exit port 110 of the ink jet cartridge 100, the plug extends into the exit port opening 120 preventing ink from leaking out of the exit port 110.

FIG. 2B displays a bottom view of the seal 200. The ribs 210 are positioned on the inside of the surrounding wall 240 and provide a securing means when the seal 200 is installed on the exit port 110 of the ink jet cartridge 100. In one embodiment, the ribs 210 may be of different diameters, i.e. the rib 210 closer to the top 230 may be of a smaller diameter than ribs 210 positioned farther away the top 230. In an illustrative embodiment, the ribs 210 may differ in diameter by about 0.01″ (0.25 mm) with each other.

FIG. 2C displays a cross sectional view of the seal 200. As shown in FIG. 2C, the inside diameter of the opening is displayed at 250. In an exemplary embodiment, the inside diameter of the opening is about 0.425″ (10.8 mm). The first rib 210 has an inner diameter of about 0.410″ (10.4 mm). There exists a difference of about 0.15″ (0.4 mm) between the first rib 210 and the opening 250. Each successive rib 210 closer to the top 230 has a smaller inner diameter than the lower rib. For example, the next rib 210 closer to the top 230 may have an inner diameter of about 0.40″ (10.16 mm), while the next closer rib 210 may have an inner diameter of about 0.390″ (9.91 mm) and so forth.

As the seal 200 is initially installed on the exit port 110, the first rib 210 may make contact. As the seal is pressed further down onto the exit port 110, each successive rib 210 makes contact with the sides of the exit port until the plug 220 is positioned into the exit port opening 120 and the inside of the top 230 makes contact with the top of the exit port 110. As displayed in FIG. 2C, the ribs 210 may also be different in thickness. When the seal 200 is installed on ink jet cartridge 100, the ribs 210 provide a securing force against the side of the exit port 110, keeping the seal 200 in place while the ink jet cartridge 100 is shipped to the consumer. Even though the ribs 210 are shown as extending around the entire inside surface of the surrounding wall 240 in other embodiments, the ribs 210 may be not be contiguous.

In one embodiment of the present invention, the seal 200 may be a single piece of thermoplastic resin such as thermoplastic rubber or thermoplastic elastomer. Alternatively, the seal may be composed of silicon rubber. In yet another alternate embodiment, the seal 200 may be composed of low density open cell foam. These types of materials may be flexible enough to easily conform to the contours of the exit port 110 and still provide enough securing force to keep the seal 200 in place. In an exemplary embodiment, the hardness of the seal 200 may be about 20-90 Shore A durometer. In addition, the plug 220 may be composed of the same material that makes up the seal 200. Alternatively, a soft compressible material such as a low density open cell foam and may be affixed into place on the inside of the top 230 using glue or other types of securing means.

In the embodiment as displayed in FIGS. 2A-C a plurality of ribs 210 may be implemented. Alternatively, other embodiments of the present invention may contain a single rib. Additionally the exit port 110 of the ink jet cartridge 100 may be cylindrical (as displayed in FIGS. 1A-B). In other ink jet cartridge types, the exit ports may be of different shapes such as rectangular, hexagonal and the like. Seals for those types of ink jet cartridges may be fitted with ribs such as those previously described without deviating from the inventive concepts as presented herein.

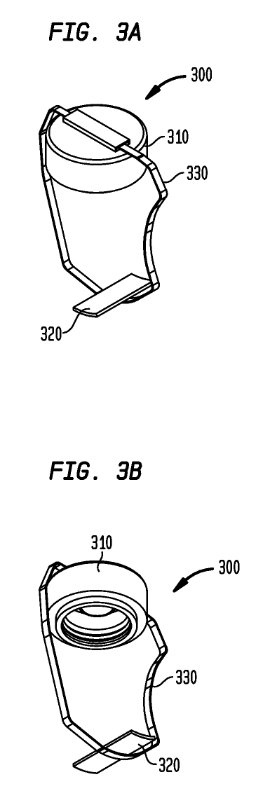

FIG. 3A-B displays an integrated seal assembly 300 in accordance with one embodiment of the present invention. The integrated seal assembly 300 consists of an exit port seal 310, connected to a vent port seal 320 by a connecting member 330. The exit port seal 310 is positioned over the exit port 110 and the vent port seal 320 is positioned over the vent port 130 of the ink jet cartridge 100. The connecting member 330 may be used to secure the exit port seal 310 and the vent port seal 320 in place and may be composed of an elastic material such as natural rubber, latex or the like. The vent port seal 320 may also have an adhesive layer (not shown for ease of illustration) helping secure the vent port seal 320 over the vent port 130.

FIG. 3B displays a bottom perspective view of the integrated seal assembly 300. In one embodiment, the exit port seal 310 may be similar to the seal 200 as shown in FIGS. 2A-C. The combination of the ribs and the connecting member 330 may provide a securing force keeping the exit port seal 310 in place. Alternatively, the exit port seal 310 may not contain any ribs and may use the connecting member 330 to secure the exit port seal 310 in place over the exit port 110. The vent port seal 320 and the exit port seal 310 may be composed of the same types of materials as previously described with regard to the seal 200 of FIGS. 2A-C. These materials may be thermoplastic resins such as thermoplastic rubber or thermoplastic elastomers, silicon rubber or low density open cell foam.

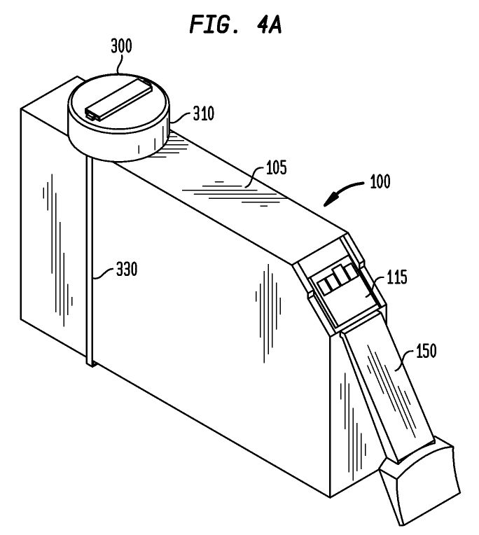

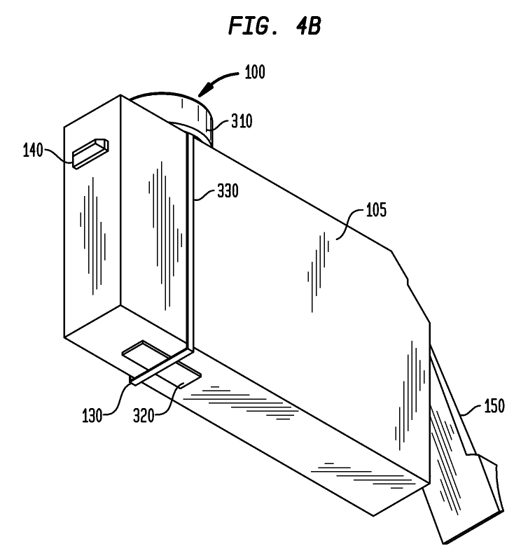

When the vent port seal 320 extends over the entire vent port 130, air is prevented from entering the ink jet cartridge 100. FIGS. 4A-B display a top and bottom perspective view of the integrated seal assembly 300 installed on the ink jet cartridge 100. Prior to installing an ink jet cartridge having an integrated seal assembly 300 affixed thereon, the consumer may remove the integrated seal assembly 300 easily thus clearing the vent port 130 and the exit port 110 simultaneously.

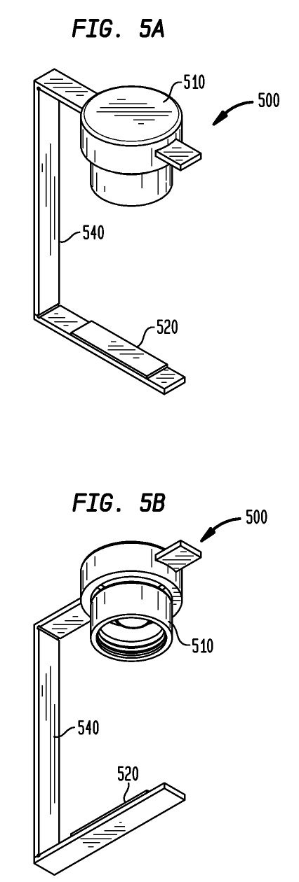

FIGS. 5A-B displays an integrated seal assembly 500 in accordance with another embodiment of the present invention. The integrated seal assembly 500 consists of an exit port seal 510, connected to a vent port seal 520 by a connecting member 540. The exit port seal 510 is positioned over the exit port 110 and the vent port seal 520 is positioned over the vent port 130 of the ink jet cartridge 100. The connecting member 540 may be a “living hinge” which may be bent and shaped into position. In this embodiment, the connecting member 540 may not provide much tension to secure the exit port seal 510 and the vent port seal 520 in position over the exit port and vent port respectively. Instead, the exit port seal 510 may be similar to the seal 200 as shown in FIGS. 2A-C. In the embodiment as shown in FIGS. 5A-B, ribs within the exit port seal 510 may provide the securing force keeping the exit port seal 510 in place. Alternatively, the exit port seal 510 may not contain any ribs but may be composed of a pliable material allowing the exit port seal 510 to be stretched over the exit port when installed. In one embodiment the integrated seal assembly 500 may be composed of a single plastic material such as thermoform or the like.

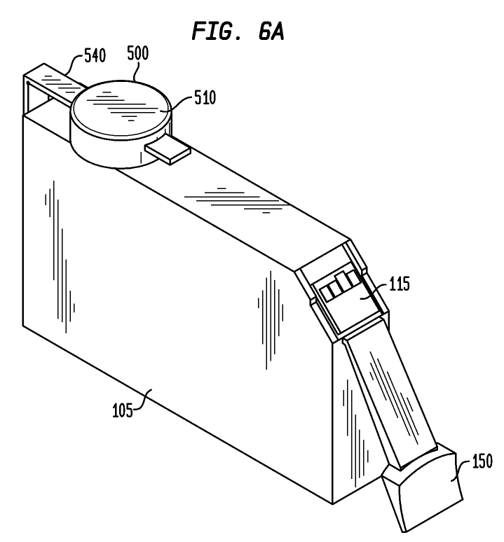

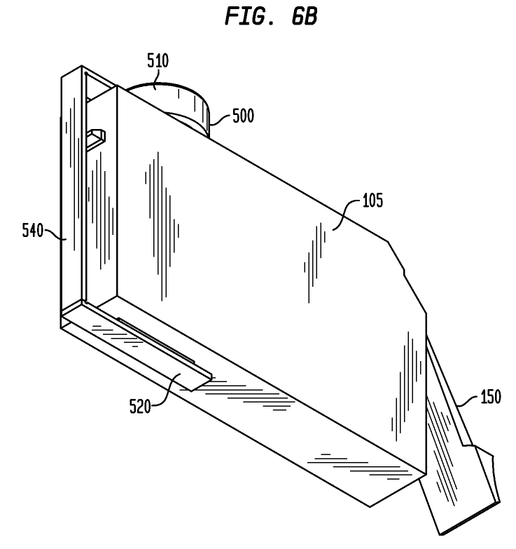

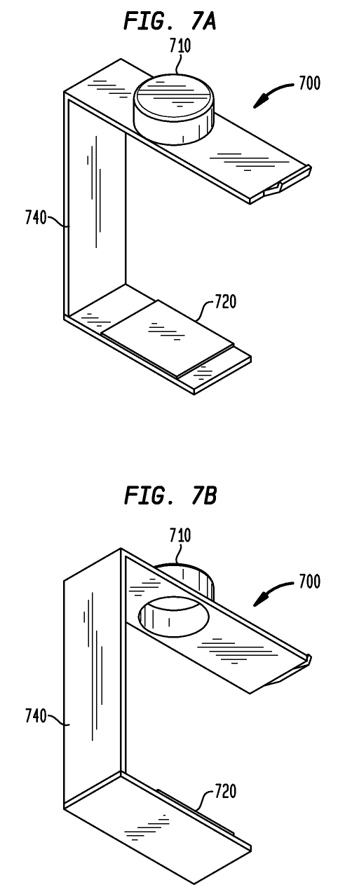

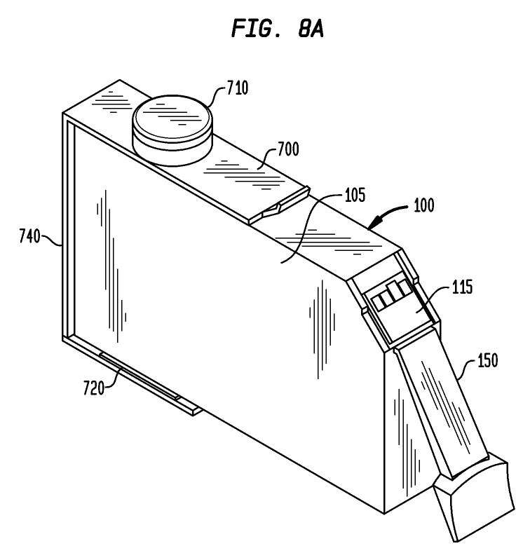

The vent port seal 520 and the exit port seal 510 may be composed of the same materials as previously described such as low density open cell foam, polyurethane, plastic or the like. In the embodiment as shown in FIGS. 5A-B, the vent port seal 520 may be affixed into place over the vent port 130 using adhesives or other types of securing means necessary to secure the vent port seal 520 in place. When the vent port seal 520 extends over the entire vent port 130, air is prevented from entering the ink jet cartridge 100. FIGS. 6A-B display a top and bottom perspective view of the integrated seal assembly 500 installed on the ink jet cartridge 100. Prior to installing an ink jet cartridge having an integrated seal assembly 500 affixed thereon, the consumer may remove the integrated seal assembly 500 easily thus clearing the vent port 130 and the exit port 110 simultaneously.

FIGS. 7A-B displays an integrated seal assembly 700 in accordance with another embodiment of the present invention. The integrated seal assembly 700 consists of an exit port seal 710, connected to a vent port seal 720 by a connecting member 740. The exit port seal 710 is positioned over the exit port 110 and the vent port seal 720 is positioned over the vent port 130 of the ink jet cartridge 100. The connecting member 740 may be used to secure the exit port seal 710 and the vent port seal 720 in place and may be composed of a metal or plastic spring. In one embodiment the connecting member 740 may exert a force of about 0.5-1.5 lbf (foot-pounds of force). In an alternative embodiment, the exit port seal 710 may be similar to the seal 200 as shown in FIGS. 2A-C. The vent port seal 720 may have an adhesive layer (not shown for ease of illustration) providing additional securing means. The combination of the ribs in the exit port seal 710, the spring tension from the connecting member 740, and the adhesive from the adhesive layer on the vent port seal 720 may provide the securing force necessary to keep the seal assembly 700 in place.

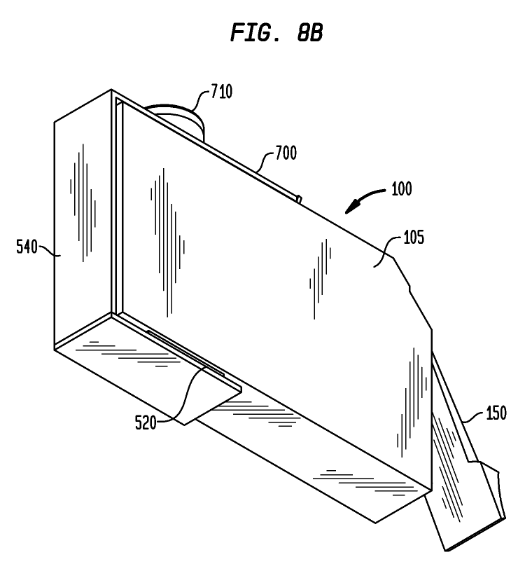

FIGS. 8A-B display a top and bottom perspective view of the integrated seal assembly 700 installed on the ink jet cartridge 100. Prior to installing an ink jet cartridge having an integrated seal assembly 500 affixed thereon, the consumer may remove the integrated seal assembly 500 easily thus clearing the vent port 130 and the exit port 110 simultaneously.

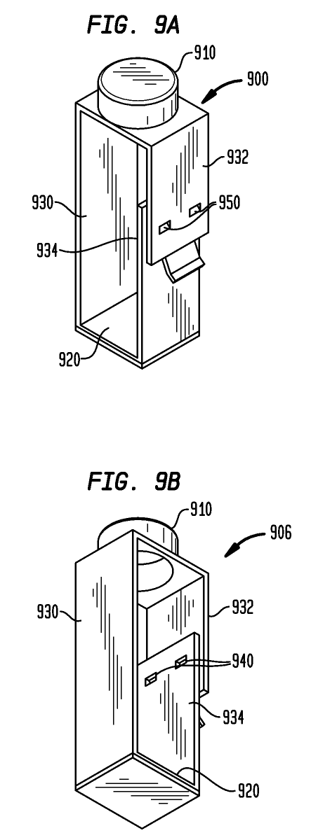

FIGS. 9A-B displays an integrated seal assembly 900 in accordance with another embodiment of the present invention. The integrated seal assembly 900 consists of an exit port seal 910, connected to a vent port seal 920 by a connecting member 930. The exit port seal 910 is positioned over the exit port 110 and the vent port seal 920 is positioned over the vent port 130 of the ink jet cartridge 100. In the embodiment as displayed in FIGS. 9A-B, the connecting member 930 may provide a securing force necessary to secure the integrated seal assembly 900 in place. The connecting member 930 may have overlapping ends comprising an outside end 932 and an inside end 934. On the outside end 932 may be securing tabs 950 which may protrude into securing tab recesses 940 located on the inside end 934. The securing force holding the exit port seal 910 and the vent port seal 920 may be provided by the elasticity of the connecting member 930 held in place by the as well as the securing tabs 950. In one exemplary embodiment, the integrated seal assembly 900 may be composed of thermoform or other type of plastic material.

The exit port seal 910 may be similar to the seal 200 as shown in FIGS. 2A-C. In this embodiment, the ribs 210 may provide additional securing force keeping the exit port seal 910 in place. Alternatively, the exit port seal 910 may not contain any ribs but may use the force provided from the elasticity of the material of the connecting member 930. In one embodiment the integrated seal assembly 900 may be composed of a single plastic material such as thermoform or the like.

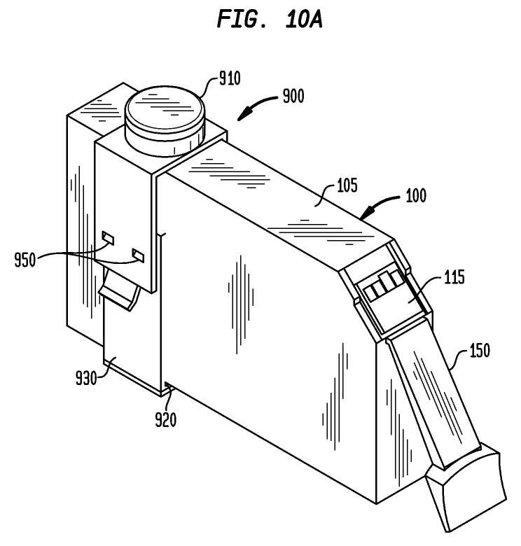

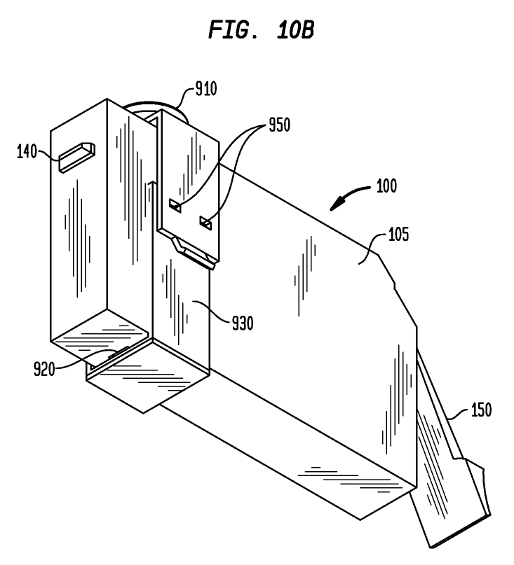

Alternatively, the integrated seal assembly 900 may be composed of various materials. In this embodiment, the vent port seal 920 may have an additional material such as low density open cell foam, polyurethane, plastic or the like layered on. Additionally, the vent port seal 920 may be affixed into place over the vent port 130 using glue or other methods of securing the vent port seal 920 in place. When the vent port seal 920 extends over the entire vent port 130, air is prevented from entering the ink jet cartridge 100. FIGS. 10A-B display a top and bottom perspective view of the integrated seal assembly 900 installed on the ink jet cartridge 100. Prior to installing an ink jet cartridge having an integrated seal assembly 900 affixed thereon, the consumer may remove the integrated seal assembly 900 easily thus clearing the vent port 130 and the exit port 110 simultaneously.

In an alternate embodiment of the present invention, the integrated seal assembly 900 of FIG. 9 may be modified to remove the securing tabs 940. In this embodiment, adhesive or the like may be added to the overlapped area created by the outside end 932 overlapping the inside end 934. Alternatively, in a non-overlapping integrated seal, adhesive may be applied to the side of the ink jet cartridge and the non-overlapping integrated seal assembly may be place over the adhesive and affixed into place.

Although specific embodiments have been illustrated and described herein, those of ordinary skill in the art appreciate that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A seal for sealing an exit port on an ink jet cartridge comprising:
a top,
a surrounding wall, the surrounding wall extending perpendicularly away from the circumference of the top, the surrounding wall having an inside surface, and;
a rib positioned on the inside surface of the surrounding wall, the rib providing a securing force when the seal is installed on the exit port of the ink jet cartridge.

2. The seal of claim 1 wherein the rib extends around the perimeter of the inside surface.

3. The seal of claim 1 wherein a plurality of ribs are positioned on the inside surface of the surrounding wall.

4. The seal of claim 3 wherein each of the ribs has a different diameter.

5. The seal of claim 1 wherein the seal is cylindrical.

6. The seal of claim 1 wherein the seal is made of a thermoplastic resin.

7. The seal of claim 6 wherein the seal is made of thermo plastic rubber.

8. The seal of claim 6 wherein the seal is made of thermoplastic elastomer.

9. The seal of claim 1 further comprising a plug wherein the plug fits into an exit port opening in the exit port when the seal is placed over the exit port.

10. An integrated seal assembly comprising:
an exit port seal for sealing an exit port on an ink jet cartridge; and,
a vent port seal for sealing a vent port on an ink jet cartridge, and;
a connecting member connecting the exit port seal with the vent port seal.

11. The integrated seal assembly of claim 10 wherein the exit port seal further comprises a top and a surrounding wall, the surrounding wall extending perpendicularly away from the circumference of the top, the surrounding wall having an inside surface, and a rib positioned on the inside surface of the surrounding wall, the rib providing a securing force when the seal assembly is installed on the exit port of the ink jet cartridge.

12. The integrated seal assembly of claim 10 wherein the connecting member is a spring.

13. The integrated seal assembly of claim 10 wherein the connecting member is elastic.

14. The integrated seal assembly of claim 13 wherein the connecting member is a latex band.

15. The integrated seal assembly of claim 10 wherein the integrated seal assembly is a single piece of thermoplastic resin.

16. The integrated seal assembly of claim 10 wherein the vent port seal is affixed into place using an adhesive.

17. The integrated seal assembly of claim 10 wherein the connecting member further comprises a first end and a second end, the first end overlapping the second end and the connecting member is secured into place by securing tabs mounted on the first end which extend into a recess on the second end.

18. The integrated seal assembly of claim 10 wherein the exit port seal is cylindrical.

19. A method for sealing an exit port and a vent port in an ink jet cartridge comprising:
providing the ink jet cartridge having the exit port and the vent port;
positioning an integrated seal assembly having an exit port seal connected to a vent port seal by a connecting member, the exit port seal positioned over the exit port and the vent port seal positioned over the vent port; and,
securing the integrated seal assembly in place.

20. The method of claim 19 wherein the connecting member is a spring.

21. The method of claim 19 wherein the exit port seal further comprises a top, a surrounding wall, the surrounding wall extending perpendicularly away from the circumference of the top, the surrounding wall having an inside surface, and a rib positioned on the inside surface of the surrounding wall, the rib providing a securing force when the seal assembly is installed on the exit port of the ink jet cartridge.

22. The method of claim 19 wherein the integrated seal assembly is made of a single piece of thermoplastic resin.

23. The method of claim 22 wherein the integrated seal assembly is composed of thermoplastic rubber.

24. The method of claim 22 wherein the integrated seal assembly is composed of thermoplastic elastomer.

25. The method of claim 19 wherein the connecting member is elastic.

26. An ink jet cartridge comprising:
an ink tank including an exit port; and
a seal for sealing the exit port on an ink jet cartridge comprising:
a top,
a surrounding wall, the surrounding wall extending perpendicularly away from the circumference of the top, the surrounding wall having an inside surface, and
a rib positioned on the inside surface of the surrounding wall, the rib providing a securing force when the seal is installed on the exit port of the ink jet cartridge.

27. An ink jet cartridge comprising:
an ink tank including an exit port and a vent port; and
an integrated seal assembly comprising:
an exit port seal for sealing an exit port on an ink jet cartridge;
a vent port seal for sealing a vent port on an ink jet cartridge; and
a connecting member connecting the exit port seal with the vent port seal.
